(19) United States
(12) Patent Application Publication
(10) Pub. No.: US 2013/0139704 A1
(43) Pub. Date: Jun. 6, 2013

(54) Cooking Vessel, Heating Device and Cooking System

(71) Applicants: Wilfried Schilling, Kraichtal (DE); Ulrich Wächter, Eppingen (DE)

(72) Inventors: Wilfried Schilling, Kraichtal (DE); Ulrich Wächter, Eppingen (DE)

(73) Assignee: E.G.O. Elektro-Geratebau GmbH, Oberderdingen (DE)

(21) Appl. No.: 13/641,415

(22) PCT Filed: Apr. 13, 2011
(86) PCT No.: PCT/EP11/55852

§ 371 Date: Feb. 20, 2013

(30) Foreign Application Priority Data
Apr. 15, 2010 (DE) 10 2010 027 833.5

(51) Int. Cl. A47J 27/00

(52) U.S. Cl. CPC A47J 27/00
USPC 99/331; 220/573.1; 219/620

(57) ABSTRACT

The disclosure relates to a cooking vessel which is of a prespecified cooking vessel type and comprises: a cooking vessel type encoding device which encodes the cooking vessel type of the cooking vessel, with the cooking vessel type encoding device being a passive, electrical resonant circuit, with a resonant frequency of the resonant circuit encoding the cooking vessel type of the cooking vessel.

### PRIORITY CLAIM

This application is the National Stage of, and claims priority to, PCT patent application PCT/EP2011/055852 filed Apr. 13, 2011, which claims the priority of German patent application DE 10 2010 027 833.5 filed Apr. 15, 2010.

### TECHNICAL FIELD

The disclosure relates to a cooking vessel, to a heating device for heating the cooking vessel, and to a cooking system.

### BACKGROUND

In order to control or regulate automatic cooking processes on induction cooking zones, it is necessary to measure the temperature of a cooking vessel base in as accurate a manner as possible. In order to measure the cooking vessel base temperature, methods are known which detect temperature-dependent electrical and/or magnetic cooking vessel base states and calculate the cooking vessel base temperature in dependence on said cooking vessel base states.

However, calculating the temperature from the detected electrical and/or magnetic cooking vessel base states is dependent on parameters that depend on the type of cooking vessel. Therefore, those type-dependent parameters or properties of the cooking vessel base that are relevant for a temperature measurement of this kind should be known.

It may further be expedient to control operation of a heating device for heating the cooking vessel in dependence on the cooking vessel type.

### SUMMARY

It should be appreciated that this Summary is provided to introduce a selection of concepts in a simplified form that are further described below in the Detailed Description. This Summary is not intended to be used to limit the scope of the claimed subject matter.

This disclosure addresses the problems discussed above by providing a cooking vessel, a heating device and a cooking system which allow cooking vessel type encoding in a manner which is as simple as possible in order to be able to ascertain the cooking vessel type in a simple manner over the course of a cooking process, in order to then take into account the properties of the cooking vessel which are relevant for heating the cooking vessel on the basis of the ascertained cooking vessel type. According to one aspect, a cooking vessel having a prespecified cooking vessel type may include a cooking vessel type encoding device. The cooking vessel type encoding device may be configured to encode the cooking vessel type of the cooking vessel and may include a passive, electrical resonant circuit with a resonant frequency of the resonant circuit encoding the cooking vessel type of the cooking vessel.

According to another aspect, a heating device for heating a cooking vessel may be configured to determine a resonant frequency of a resonant circuit of the cooking vessel. The heating device may be further configured to identify the type of the cooking vessel from the determined resonant frequency, and to set heating parameters according to the identified cooking vessel type.

According to a further aspect, a cooking system may include a cooking vessel and a heating device. The cooking vessel may have a cooking vessel type encoding device configured to encode the cooking vessel type of the cooking vessel, and may include a passive, electrical resonant circuit with a resonant frequency of the resonant circuit encoding the cooking vessel type of the cooking vessel. The heating device may be configured to determine a resonant frequency of a resonant circuit of the cooking vessel. The heating device may be further configured to identify the type of the cooking vessel from the determined resonant frequency, and to set heating parameters according to the identified cooking vessel type.

These and further features emerge not only from the claims but also from the description and from the drawings, wherein the individual features can be realized, and can constitute embodiments which are advantageous and which are protectable per se and for which protection is claimed here, in each case on their own or as a plurality in the form of subcombinations in an embodiment of the disclosure and in other fields. The subdivision of the application into individual sections and subheadings does not restrict the statements made under them in terms of their general validity.

### BRIEF DESCRIPTION OF THE DRAWINGS

Advantageous embodiments of the disclosure are schematically illustrated in the drawings and will be described below. In the drawings:

FIG. 1 shows an exemplary illustration of a cooking system according to the various embodiments of the disclosure;

FIG. 2 shows a further illustration of a cooking system according to various embodiments of the disclosure; and

FIG. 3 shows a plan view of a resonant circuit for cooking vessel type encoding according to various embodiments of the disclosure.

### DETAILED DESCRIPTION

The cooking vessel according to the disclosure herein may be of a prespecified cooking vessel type. Cooking vessel type-specific electrical and magnetic cooking vessel base properties, for example, are associated with a prespecified cooking vessel type. A distinction can be drawn between different cooking vessel types, for example, by virtue of their properties in this respect. The cooking vessel comprises a cooking vessel type encoding device which encodes or reproduces or represents the cooking vessel type of the cooking vessel. The cooking vessel type encoding device is a passive, electrical resonant circuit, with a resonant frequency of the resonant circuit encoding the cooking vessel type of the cooking vessel. In this case, different cooking vessel types have different resonant frequencies, as a result of which the respective cooking vessel type of the cooking vessel can be ascertained in a simple manner on the basis of the specific resonant frequency.

In embodiments described herein, the resonant circuit may be an LC resonant circuit, that is to say the resonant circuit comprises a coil or inductance L and a capacitor or capacitance C. According to embodiments described herein, the resonant circuit may be in the form of a thin-film structure or in the form of a thick-film structure, in particular on or in the region of the cooking vessel base.

In embodiments described herein, a cooking vessel base may have an electrically insulating layer, with an interconnect structure which forms the resonant circuit being applied to, in particular printed on, the electrically insulating layer. In various embodiments described herein, the resonant circuit comprises a capacitor, which is in the form of a discrete component.

According to various embodiments described herein, the cooking vessel may have an inner shell and an outer shell, it being possible to inductively heat the inner shell, and the outer shell being at least partially composed of thermally and/or electrically insulating material, with the resonant circuit being formed from a conductive material on a surface of the outer shell which is composed of the electrically insulating material and which faces the inner shell. The heating device according to the disclosure herein is designed to heat the abovementioned cooking vessel. The heating device is further designed to determine the resonant frequency of the resonant circuit, to ascertain the cooking vessel type from the determined resonant frequency, and to set heating parameters, for example an actuation frequency, an actuation amplitude, calibration variables etc., in a cooking vessel type-specific manner depending on the ascertained cooking vessel type.

In various embodiments described herein, the heating device may be an induction heating device which generates a medium-frequency alternating magnetic field, for example an alternating field in a frequency range of from 10 kHz to 100 kHz, which is used to heat the cooking vessel, with switching edges which are produced when the alternating magnetic field is generated being used to excite the resonant circuit. The heating device may comprise a receiving device which receives signals which are generated by the resonant circuit, in order to determine the resonant frequency. The cooking system described herein may comprise an above-described cooking vessel and an above-described heating device.

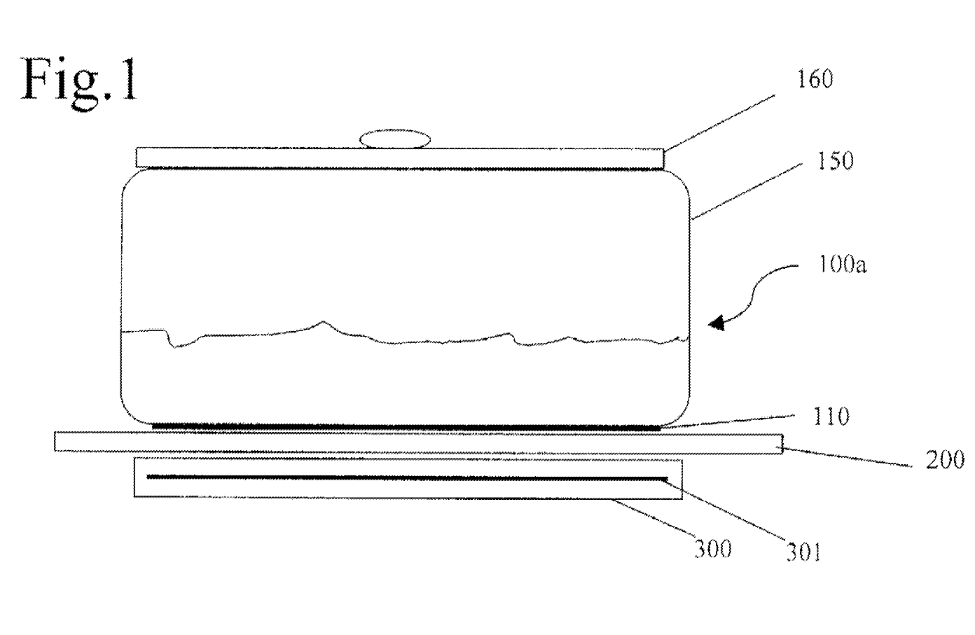

Turning now to the drawings, FIG. 1 shows a detail of a cooking system according to various embodiments having a cooking vessel 100a and a heating device 300. The cooking vessel may be a pot with a pot wall 150 on which a lid 160 is arranged. A base of the pot or the pot wall 150 is composed of ferromagnetic material in order to allow the pot base to be inductive heated.

A cooking vessel type encoding device in the form of a passive, electrical LC resonant circuit 110 is provided on the outside of the pot base, with a resonant frequency of the LC resonant circuit 110 encoding the cooking vessel type of the cooking vessel 100a. The resonant frequency of the LC resonant circuit 110 shown can be, for example, 10 MHz. Cooking vessel type-specific properties which relate, for example, to electrical and magnetic properties of the cooking vessel base which are relevant for inductively heating the cooking vessel base using the heating device 300 are associated with the shown cooking vessel type or the resonant frequency of 10 MHz.

The LC resonant circuit 110 may be in the form of a thin-film structure or in the form of a thick-film structure on the cooking vessel base. An electrically insulating layer (not shown) can be arranged between the resonant circuit 110 and the cooking vessel base, with an interconnect structure which forms the resonant circuit 110 being applied to, for example printed on, this electrically insulating layer.

The cooking vessel 100a may be placed on a conventional glass-ceramic hob 200 during operation, with the heating device 300 being arranged beneath the glass-ceramic hob. According to various embodiments, the heating device 300 is in the form of an induction heating device 300 and comprises a conventional, helically wound induction heating coil 301 which is actuated by means of a conventional converter (not shown) in order to generate a medium-frequency alternating magnetic field which generates eddy currents and remagnetization losses in the ferromagnetic pot base, as a result of which the pot base is heated. Switching edges which are used to excite the resonant circuit 110 are produced when the alternating magnetic field is generated.

The heating device 300 comprises a receiving device (not illustrated in any detail), for example having a receiving antenna, which is designed to receive signals which are generated by the resonant circuit 110. An alternating magnetic field can be generated during operation of the induction heating device 300, for example in heating time intervals, it being possible to briefly interrupt the heating operation in measurement time intervals for the purpose of determining the resonant frequency of the resonant circuit 110, in order to allow the resonant circuit 110 to oscillate at its resonant frequency, with the resonant frequency in the heating device 300 being determined in these measurement time intervals. However, on account of the large distance between the two operating frequencies of preferably 20 kHz in the inductive heating device 300 and 10 MHz at the resonant frequency of the resonant circuit 110, the resonant frequency can also be measured during the heating operation, that is to say during a heating time interval.

The heating device 300 is designed to determine the cooking vessel type of the cooking vessel 100a from the determined resonant frequency and to set heating parameters in a cooking vessel type-specific manner in dependence on said cooking vessel type in order to allow the cooking vessel 100a to be heated in an optimum manner.

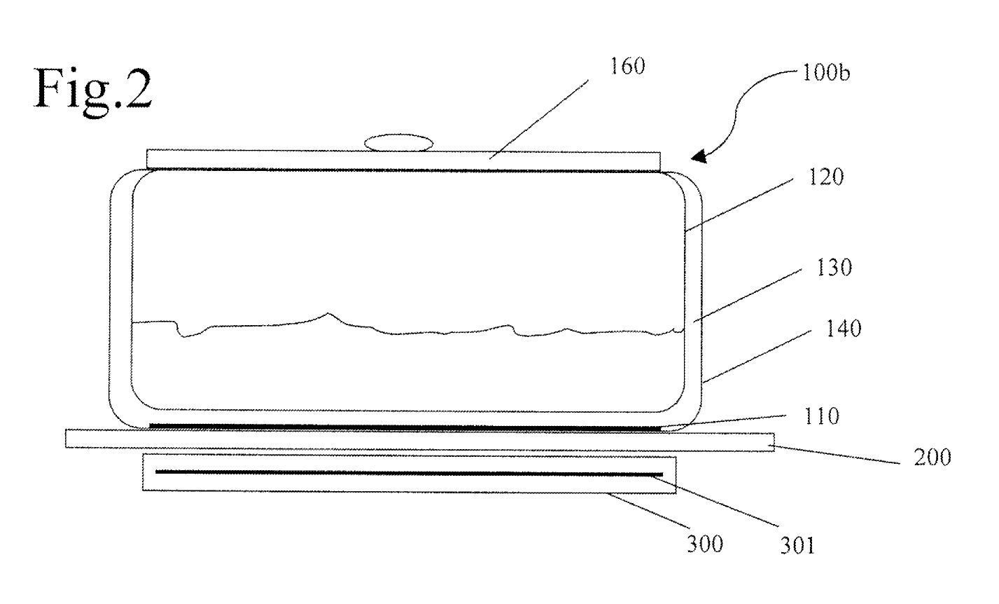

FIG. 2 shows a second embodiment of a cooking system having a double-shell cooking vessel 100b, with the remaining components corresponding to those in FIG. 1. The cooking vessel shown in FIG. 2 has an inner shell 120 that is composed of ferromagnetic material at least in its base region and therefore can be inductively heated. The inner shell 120 is surrounded by an outer shell 140, which is composed of thermally and electrically insulating material. An insulating layer 130 is inserted between the shells 120 and 140. In this embodiment, the LC resonant circuit 110 is formed in the base region on a surface of the outer shell 140 that faces the inner shell 120.

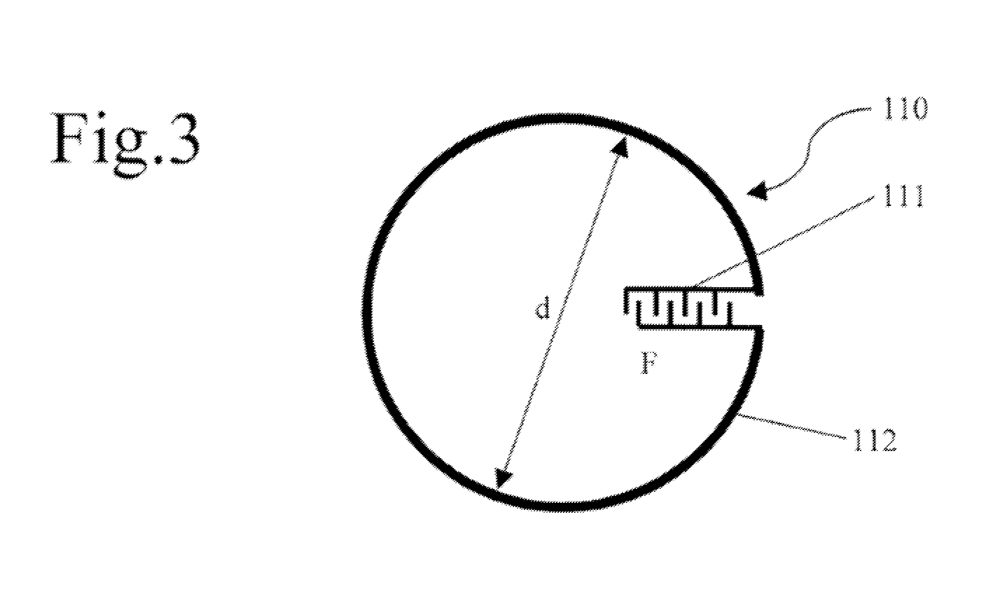

FIG. 3 shows an embodiment of the resonant circuit 110 that is shown in FIGS. 1 and 2 and has a coil turn 112 and a comb-like capacitor 111. The specific resonant frequency of the shown resonant circuit 110 can be varied by a diameter d of the coil turn 112 and/or a capacitor surface F being changed.

The shown embodiments share the common feature that a passive electrical resonant circuit which is excited to oscillate by means of high-frequency switching pulses of the induction heating device 300 is integrated in the cooking vessel for cooking vessel type identification. The resonant circuit 110 at the same time also forms a transmitting antenna, it being possible for the signals emitted by said transmitting antenna to be received in the induction heating device 300, as a result of which the cooking vessel type can be identified.

Different cooking vessel types have different, that is to say cooking vessel type-specific, resonant frequencies on account of a different dimensioning of the respectively associated resonant circuits. The induction heating device 300 or its receiving unit has, for example, a tunable, selective receiver which suppresses interference due to operation of the induction heating device 300. The received frequency which is typical of a cooking vessel type or a cooking vessel sort can be used to identify the type and to select an associated parameter set.

The resonant circuit 110 can be realized in a different way. For example, an insulating layer can be printed on the lower face of the cooking vessel base and an interconnect structure which forms the resonant circuit 110 with its inductive and capacitive components can be printed on said insulating layer. Different frequencies can be achieved by varying the geometric arrangement.

The resonant circuit 110 can be produced, for example, by a full-surface, electrically conductive coating, which is applied to an electrically insulating layer, being patterned by means of a laser in such a way that one or more turns are formed, said turns forming the resonant circuit 110 together with a capacitor which is inserted as a discrete component. Instead of a discrete capacitor component, a parasitic capacitance of the turn or of the turns can be used as the resonant circuit capacitor. As an alternative or in addition, a structure which meshes in the form of a comb can form the capacitor, also see FIG. 3 in this respect.

The resonant circuit 110 can be excited by the switching edges which are produced during conventional operation of the induction heating device 300. As an alternative or in addition, the resonant circuit 110 can be excited by a pulse generator which is to be provided separately. The resonant frequency of the resonant circuit 110 can be determined by means of a selective receiver in the induction heating device 300.

The resonant circuit can be formed, for example, on the cooking vessel base as a thick- or thin-film structure. As an alternative, the resonant circuit can be formed on the pot base by copper or aluminum foil and a discrete capacitor.

In addition to its type encoding function, the resonant circuit can also be used to measure the temperature of the cooking vessel base. In this case, a temperature dependency of the resonant frequency of the resonant circuit 110 can be evaluated, with the temperature-related change in the resonant frequency being so low that the same cooking vessel type is always displayed independently of the temperature.

The shown heating device and the shown cooking system can also operate using cooking vessels which do not have a cooking vessel type encoding device. If the absence of a cooking vessel type encoding device is detected, a changeover can be made, for example, to a normal program.

The shown embodiments allow cooking vessel type encoding in a simple manner, it being possible for the properties of the cooking vessel that are relevant for heating the cooking vessel to be ascertained in a simple manner by a heating device on the basis of said cooking vessel type encoding.

1. A cooking vessel having a prespecified cooking vessel type, comprising:
a cooking vessel type encoding device configured to encode the prespecified cooking vessel type of the cooking vessel, wherein the cooking vessel type encoding device comprises a passive, electrical resonant circuit, with a resonant frequency of the resonant circuit encoding the cooking vessel type of the cooking vessel.

2. The cooking vessel of claim 1, wherein the resonant circuit comprises an LC resonant circuit.

3. The cooking vessel of claim 1, wherein the resonant circuit comprises a thin-film structure or a thick-film structure, arranged on a cooking vessel base.

4. The cooking vessel of claim 1, wherein a cooking vessel base comprises an electrically insulating layer, wherein a conductive path structure forming the resonant circuit is arranged on the electrically insulating layer.

5. The cooking vessel of claim 1, wherein the resonant circuit comprises a capacitor as a discrete component.

6. The cooking vessel of claim 1, wherein the cooking vessel comprises an inner shell and an outer shell, the inner shell being inductively heatable, and the outer shell being at least partially composed of thermally and electrically insulating material, with the resonant circuit being formed from a conductive material on a surface of the outer shell which is composed of the electrically insulating material and which faces the inner shell.

7. A heating device for heating a cooking vessel, wherein the heating device is configured to determine a resonant frequency of a resonant circuit of the cooking vessel, to identify a cooking vessel type of the cooking vessel from the determined resonant frequency, and to set heating parameters in a cooking vessel type-specific manner depending on the cooking vessel type.

8. The heating device of claim 7, wherein the heating device comprises an induction heating device configured to generate a medium-frequency alternating magnetic field which is used to heat the cooking vessel, with switching edges produced when the medium-frequency alternating magnetic field is used to excite the resonant circuit.

9. The heating device of claim 7, wherein the heating device comprises a receiving device which receives signals generated by the resonant circuit.

10. A cooking system comprising:
a cooking vessel type encoding device configured to encode the prespecified cooking vessel type of the cooking vessel, wherein the cooking vessel type encoding device comprises a passive, electrical resonant circuit, with a resonant frequency of the resonant circuit encoding the cooking vessel type of the cooking vessel; and
a heating device for heating the cooking vessel, wherein the heating device is configured to determine the resonant frequency of the resonant circuit of the cooking vessel, to identify the prespecified cooking vessel type of the cooking vessel from the determined resonant frequency, and to set heating parameters in a cooking vessel type-specific manner depending on the cooking vessel type.
